(19) United States
(12) Patent Application Publication
(10) Pub. No.: US 2013/0205530 A1
(43) Pub. Date: Aug. 15, 2013

(54) SIMPLE SPEED TRIM TOOL

(71) Applicant: James Dale, London, KY (US)

(72) Inventor: James Dale, London, KY (US)

(21) Appl. No.: 13/764,772

(22) Filed: Feb. 11, 2013

Related U.S. Application Data
(60) Provisional application No. 61/597,639, filed on Feb. 10, 2012.

(51) Int. Cl. B05C 17/02

(52) U.S. Cl. CPC B05C 17/02
USPC 15/230.11

(57) ABSTRACT

A painting tool allows a consumer to paint around trim or an adjoining wall or surface without preparation tape or other time consuming methods prior to the actual paint application. The painting tool includes a guide guard that is activated into a working position by a switch on its handle. With the guide guard in place, the user can trim close to adjoining surfaces without getting paint on them. This is typically referred to as “cutting in”. There may be a calculated gap between the guide shield and the end of the working paint roller cover that works with the natural flow of the paint to cut in close to the unpainted surface.

### CROSS-REFERENCE TO RELATED APPLICATION

This application claims the benefit of priority of U.S. provisional application No. 61/597,639, filed Feb. 10, 2012, the contents of which are herein incorporated by reference.

### BACKGROUND OF THE INVENTION

The present invention relates to painting tools and, more particularly, to a painting tool for trim and cut-in applications that also performs as a mini roller.

Typically, trimming and cutting-in painting is performed with a paint brush or by taping the trim or surface that you do not want to be painted. Trimming free-hand, without taping takes skill and practice to form uniform straight trim lines. Taping, while resulting in good trim lines, takes considerable time and, if not done properly, can result in seepage or peeling of paint.

As can be seen, there is a need for painting tool that may give good trim lines without the need for taping.

### SUMMARY OF THE INVENTION

In one aspect of the present invention, a painting tool comprises a frame having a handle and a roller attachment arm; a guide shield movable between an open position and a closed position; and a guide shield lock adapted to retain the guide shield in a desired position, wherein the guide shield provides a fixed space between an edge of a roller cover disposed on the frame and an outer edge of the guide shield.

In another aspect of the present invention, a painting tool comprises a frame having a handle and a roller attachment arm; a roller cover having a roller cover end cap disposed on one end of the roller cover; a guide shield movable between an open position and a closed position; a guide shield lock adapted to retain the guide shield in a desired position; a slide switch operable to move the guide shield between the open position and the closed position, wherein the guide shield provides a fixed space between an edge of the roller cover disposed on the frame and an outer edge of the guide shield; and the paint shield includes an indent for receiving the roller cover end cap when in an engaged configuration.

These and other features, aspects and advantages of the present invention will become better understood with reference to the following drawings, description and claims.

### BRIEF DESCRIPTION OF THE DRAWINGS

FIG. 1 is a perspective view of a speed trim tool, in use with the shield deployed to apply paint to an edge surface, according to an exemplary embodiment of the present invention;

FIG. 2 is a perspective view of the speed trim tool of FIG. 1, in use with the shield retracted to acquire paint from a paint tray, according to an exemplary embodiment of the present invention;

FIG. 3 is a perspective view of the speed trim tool of FIG. 1, illustrating the paint shield moving from an in a retracted position and the roller cover moved between in installed and uninstalled position on the arm of the tool;

FIG. 4 is a perspective view of the speed trim tool of FIG. 1, illustrating the paint shield in the engaged configuration and a lock tab in an unlocked configuration;

FIG. 5 is a perspective view of the speed trim tool of FIG. 1, illustrating the paint shield in the engaged configuration and the lock tab in a locked configuration;

FIG. 6 is an exploded view of a lower end of the speed trim tool of FIG. 1, illustrating application of an extension rod thereto;

FIG. 7 is a perspective view of the speed trim tool of FIG. 1 with the extension rod attached thereto; and

FIG. 8 is a front view of the speed trim tool of FIG. 1, in use to apply paint to a surface along an edge.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a painting tool that allows a consumer to paint around trim or an adjoining wall or surface without preparation tape or other time consuming methods prior to the actual paint application. The painting tool includes a guide guard that is activated into a working position by a switch on its handle. With the guide guard in place, the user can trim close to adjoining surfaces without getting paint on them. This is typically referred to as “cutting in”. There may be a calculated gap between the guide shield and the end of the working paint roller cover that works with the natural flow of the paint to cut in close to the unpainted surface.

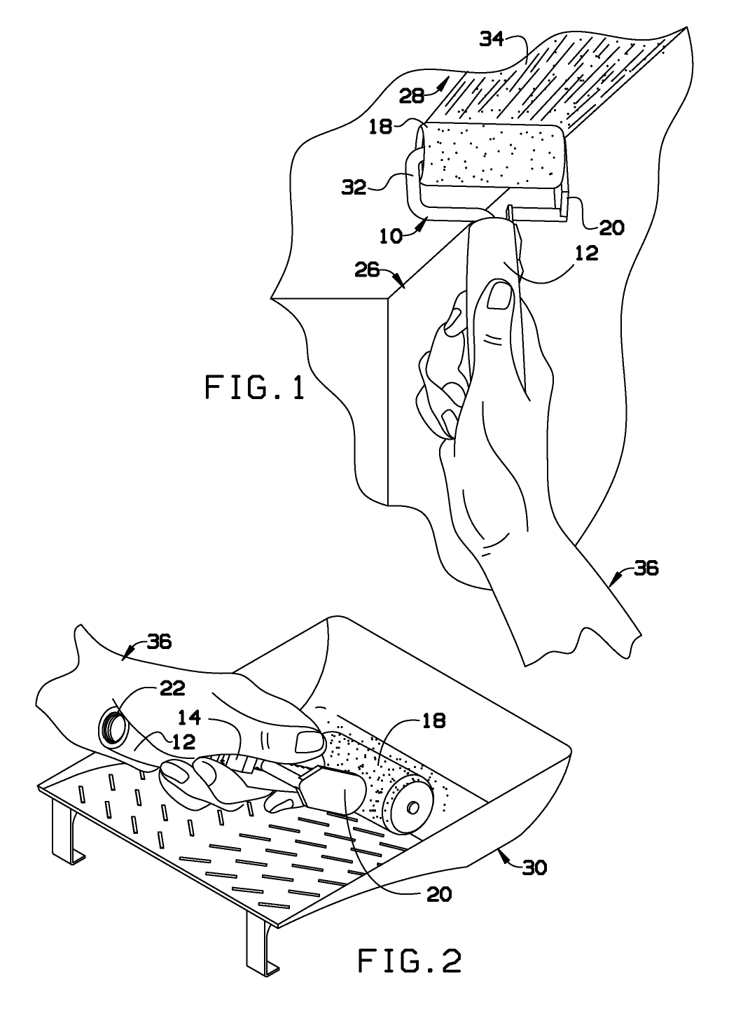

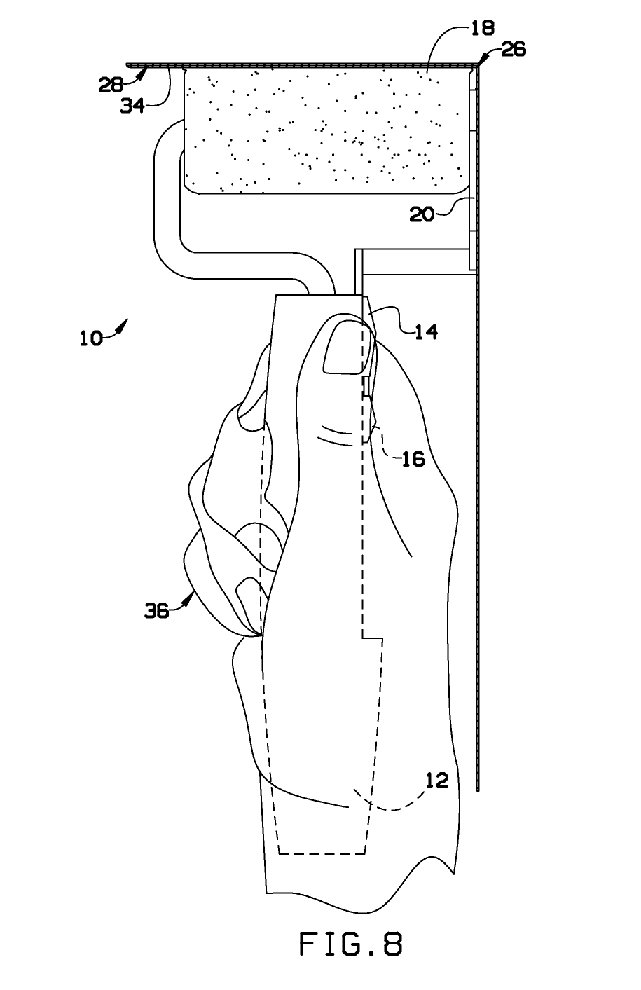

Referring now to FIGS. 1 through 8, a trim painting tool 10 may include a stick shank roller arm 32 over which a roller cover 18 may be disposed. The stick shank roller arm 32 may be, for example, a typical 5 mm or 7 mm stick shank. In some embodiments, a cage roller may be used. The roller cover 18 may be a hi-density or flocked foam roller cover, for example. Typically, the trim painting tool 10 may have a handle 12 made of, for example, polypropylene, ABS, TPR, or the like. The shank roller arm 32 of the trim painting tool 10 is typically made of, for example, a metal such as plated steel.

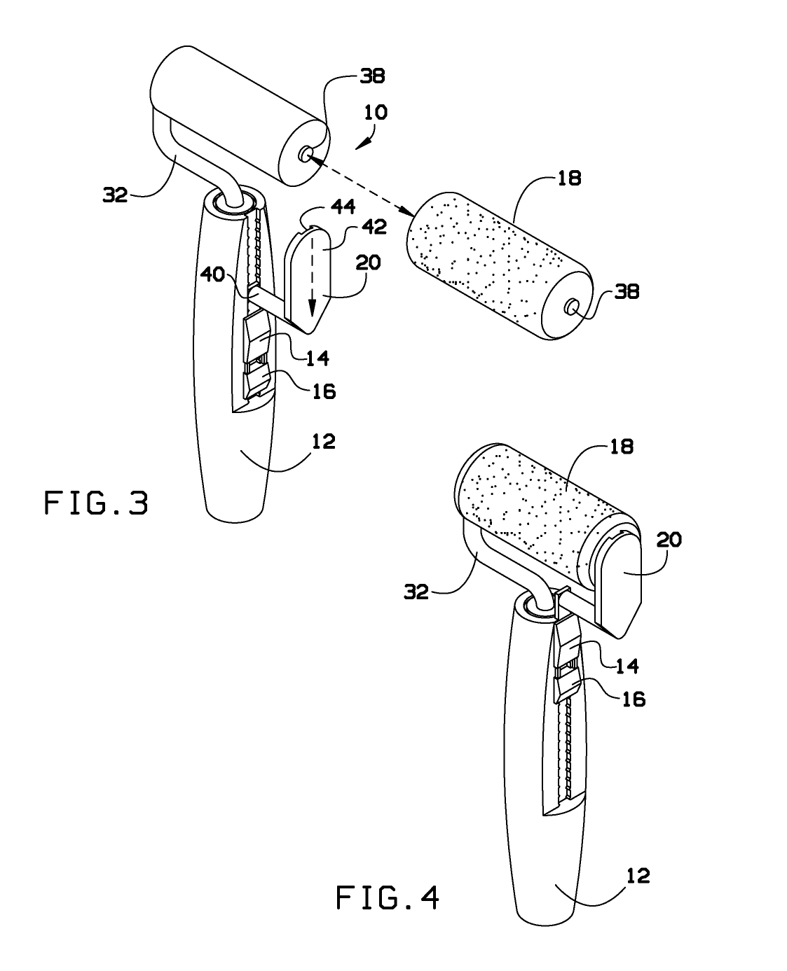

A guide paint shield 20 may be movable between a first, open position (as shown in FIG. 3) and a second, closed position (as shown in FIG. 4). The guide paint shield 20 may be made from various materials, such as plastic, stainless steel, or the like. The guide paint shield 20 may include a shaft 40 extending generally perpendicular from the handle 12. A shield member 42 may extend from the end of the shaft 40, running generally parallel to the handle 12. A sliding button 14 may slide the shaft 40 along a portion of the length of the handle 12. A lock tab 16 may lock the guide paint shield 20 in position. Typically, the lock tab 16 may frictionally retain the sliding button 14, although other mechanisms, as may be known in the art, may be used to hold the sliding button 14, and therefore the guide paint shield 20, in a given position.

To use the trim painting tool 10, a user 36 may first load a roller cover 18 onto the arm 32. Typically, the roller cover 18 will be designed to fit exclusively with the roller frame of the present invention and will only fit onto the frame in one direction. Once loaded, the user 36 may use a paint tray 30 to load paint 34 onto the roller cover 18. Typically, this is done with the guide paint shield/guide guard 20 in the open position to prevent paint from getting onto the shield 20 as shown in FIG. 2.

The roller cover 18 can include a roller cover end cap 38 protruding from an end of the roller cover 18. The paint shield 20 can include an indent 44 operable to receive the roller cover end cap 38 when the paint shield 20 is in an engaged configuration.

Once paint is loaded, the user may close the shield 20, which may create a fixed space between the roller cover 18 and the end of the shield 20. This may be useful for cutting in along trim or at a corner 26, for example. The fixed space may be from about 2 to about 4 mm, typically about 2.5 mm. The wall 28 being painted is the only surface to get painted while the adjoining wall or trim stays clean.

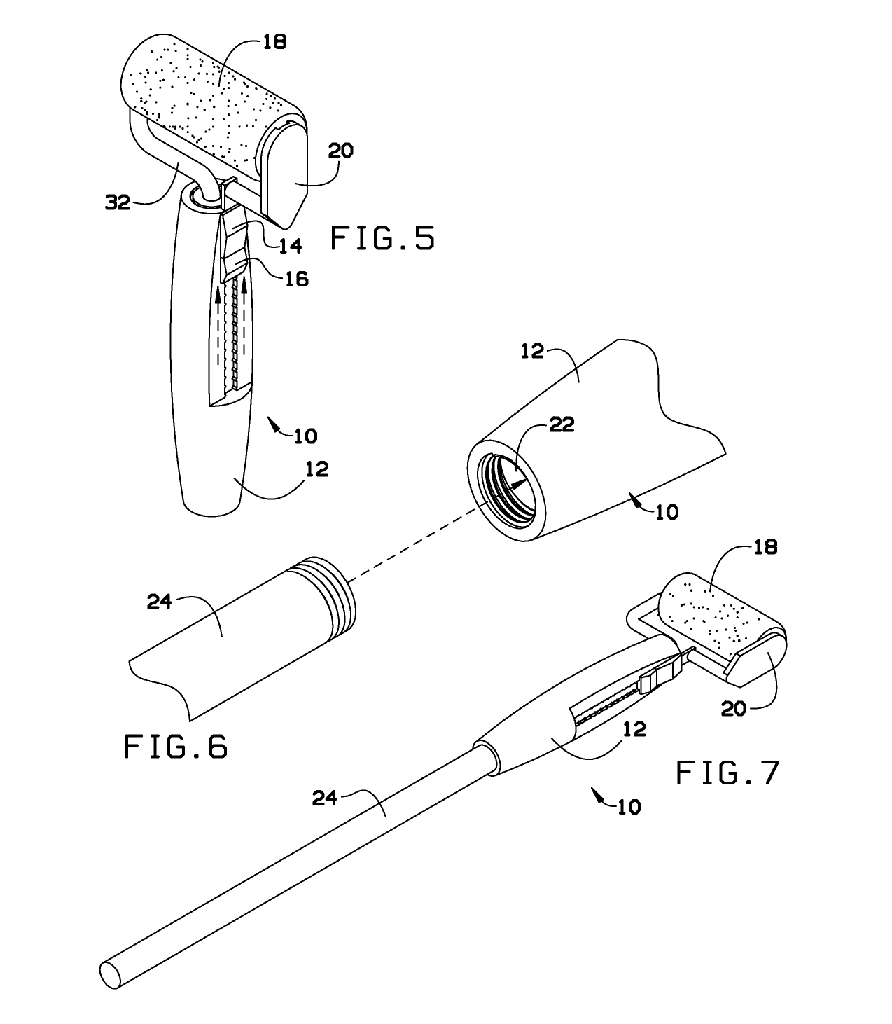

As shown in FIGS. 6 and 7, the handle 12 of the trim painting tool 10 may be adapted to fit onto an extension handle/pole 24. The painting tool handle 12 may be adapted to fit standard threaded or tapered extension handles, for example with a female threaded hole 22, for example, for insertion of the extension handle/pole 24.

The trim painting tool 10 of the present invention may be used in both a right-hand guard position or a left-hand guard position. This feature is a result of the symmetrical design of the painting tool. This feature allows the tool to be used along various edges.

It should be understood, of course, that the foregoing relates to exemplary embodiments of the invention and that modifications may be made without departing from the spirit and scope of the invention as set forth in the following claims.

What is claimed is:

1. A painting tool comprising:
a frame having a handle and a roller attachment arm;
a guide shield movable between an open position and a closed position; and
a guide shield lock adapted to retain the guide shield in a desired position, wherein
the guide shield provides a fixed space between an edge of a roller cover disposed on the frame and an outer edge of the guide shield.

2. The painting tool of claim 1, further comprising a slide switch operable to move the guide shield between the open position and the closed position.

3. The painting tool of claim 1, further comprising an extension handle insertion hole at a distal end of the handle.

4. The painting tool of claim 1, wherein the guide shield includes a shaft extending generally perpendicular from the handle and a shield member extending from an end of the shaft, running generally parallel to the handle.

5. The painting tool of claim 4, wherein the shield member is from about 2 to about 4 mm thick.

6. The painting tool of claim 4, further comprising a roller cover end cap disposed on one end of the roller cover.

7. The painting tool of claim 6, wherein the shield member includes an indent for receiving the roller cover end cap when in an engaged configuration.

8. A painting tool comprising:
a frame having a handle and a roller attachment arm;
a roller cover having a roller cover end cap disposed on one end of the roller cover;
a guide shield movable between an open position and a closed position;
a guide shield lock adapted to retain the guide shield in a desired position;
a slide switch operable to move the guide shield between the open position and the closed position, wherein
the guide shield provides a fixed space between an edge of the roller cover disposed on the frame and an outer edge of the guide shield; and
the paint shield includes an indent for receiving the roller cover end cap when in an engaged configuration.

9. The painting tool of claim 8, further comprising an extension handle insertion hole at a distal end of the handle.

10. The painting tool of claim 8, wherein the guide shield includes a shaft extending generally perpendicular from the handle and a shield member extending from an end of the shaft, running generally parallel to the handle.

11. The painting tool of claim 10, wherein the shield member is from about 2 to about 4 mm thick.
